(19) United States
(12) Patent Application Publication
(10) Pub. No.: US 2007/0219827 A1
(43) Pub. Date: Sep. 20, 2007

(54) APPARATUS FOR PROCESSING A PRESCRIPTION AND METHOD OF USING SAME

(76) Inventor: Michael H. Green, Wayne, NJ (US)

Correspondence Address: GFD PATENTS, LLC, P.O. BOX 752, CLIFTON PARK, NY, 12065, US

(21) Appl. No.: 11/688,239

(22) Filed: Mar. 19, 2007

Related U.S. Application Data
(60) Provisional application No. 60/743,592, filed on Mar. 20, 2006.

(51) Int. Cl. G06Q 10/00; G06Q 40/00

(52) U.S. Cl. 705/2; 705/4

(57) ABSTRACT

An apparatus for processing a prescription and method of using same for processing a prescription for a patient, comprising: at least one storage device; and a processor disposed in communication with the at least one storage device, the at least one storage device storing: a program for controlling the processor; and the processor operative with the program to: receive a request for a drug or a drug homolog having a therapeutic category and a managed care formulary status from at least one prescriber/physician and/or at least one managed care provider and/or from at least one pharmaceutical or other provider of the drug; transmit the messaging to the at least one prescriber/physician; and the physician/prescriber selecting the drug or the drug homolog in the therapeutic category by the at least one prescriber/physician to process the prescription.

The present patent application is a non-provisional application claiming priority from provisional application with Ser. No. 60/743,592 (filed Mar. 20, 2006 and entitled “APPARATUS FOR PROCESSING A PRESCRIPTION AND METHOD OF USING SAME”).

### FIELD OF USE

The present invention relates generally to devices and methods for obtaining information, and more specifically to providing valuable, brand supporting products and services for physicians and their patients at the point of prescription.

### BACKGROUND

There is a need for providing resources that offer valuable, brand supporting products and services for physicians and their patients at the point of prescription.

### SUMMARY OF THE INVENTION

A first aspect of the present invention provides an apparatus for processing a prescription for a patient, comprising: a storage device; and a processor disposed in communication with the storage device, the storage device storing: a program for controlling the processor; and the processor operative with the program to: receive a request for a drug having a therapeutic category and managed care formulary status from at least one prescriber/physician; transmit messaging for the drug and/or drug homolog in the therapeutic category and managed care formulary status that has been pre-determined by at least one pharmaceutical or other provider of the drug to the at least one prescriber/physician and to the managed care provider; and select the drug or the drug homolog in the therapeutic category by the at least one prescriber/physician to process the prescription.

A second aspect of the present invention provides A method of processing a prescription, comprising: receiving a request for a drug having a therapeutic category and managed care formulary status from at least one physician/prescriber; transmitting messaging for the drug and/or drug homolog in the therapeutic category and managed care formulary status that has been pre-determined by at least one pharmaceutical or other provider of the drug to the at least one prescriber/physician and to the managed care provider; and selecting the drug or the drug homolog in the therapeutic category by the at least one prescriber/physician to process the prescription.

### BRIEF DESCRIPTION OF THE DRAWINGS

FIG. 1 depicts a method for processing a prescription, according to embodiments of the present invention;

FIG. 2 depicts a split screen presentation of messaging from three different pharmaceutical suppliers, according to embodiments of the present invention;

FIG. 3 depicts a split screen format showing formulary data and pharma sponsored messaging, according to embodiments of the present invention;

FIG. 4 depicts a split screen format illustrating multi-sponsored messaging, according to embodiments of the present invention; and

FIG. 5 is a schematic block diagram of a general-purpose computer, according to embodiments of the present invention.

### DESCRIPTION OF THE INVENTION

Challenges facing Pharma: Few, if any, Pharma supported websites exist that offer valuable, brand supporting products and services for physicians and their patients at the point of prescription.

The increasing adoption of e-prescribing systems and the availability of managed care formulary information in an electronic format may disintermediate more and more brand prescriptions, e.g. tiered formularies adversely affecting brand prescriptions, looming patent expirations may increase generic availability and valuable patient and brand benefiting services such as compliance/persistency/adherence programs are difficult to implement at the point-of-care/point-of-prescription. Ito and Blackburn (1995) define a managed care formulary as “a listing of prescription medications which are preferred for use by a health plan.” Hereinafter, “disintermediate” means withdrawing the drug from the use by the physician or the patient because of financial and/or usage barriers erected by the managed care community that interfere or prohibit access to the drug. Up to this point, there has been no way for Pharma to counter the influence of formulary status in the physician prescribing process or deliver brand supporting information and services at the point-of-care.

The apparatus 400 and the method 1 were developed by Prescribing Resources to address these challenges. A goal is to provide Pharma a greater presence with physicians as their prescribing is impacted by the availability of electronic information at the point-of-care.

The apparatus 400 and the method 1 of Prescribing Resources websites may offer include:
1) Full package insert and concise prescribing information for approved prescription drugs along with the opportunity for Pharma messaging;
2) A proprietary system that offers plan based managed care formulary information along with the opportunity to deliver valuable Pharma messaging alongside the formulary data; and
3) A web-based ASP model ePrescribing system offered FREE to physicians who register and are validated against a prescriber database. System may allow for valuable Pharma messaging.
4) The combination of these services may generate significant physician traffic and usage. The apparatus 400 and the method 1 may provide Drug Information. For example, Comprehensive, up-to-date, list of Food and Drug Administration (FDA) approved labels as found in medication package inserts in the FDA DailyMed database or any other appropriate prescription drug data base. The apparatus 400 and the method 1 may provide the FDA DailyMed database. The apparatus 400 and the method 1 may provide a concise drug data for quick reference. The apparatus 400 and the method 1 may enable electronic prescribing by interfacing to an electronic prescription facilitator, such as RxHub, SureScripts and Council On Affordable Healthcare (CAQH) to offer the most complete and reliable single source of formulary data from health plans and Pharmaceutical Benefit Managers (PBMs) that together cover a majority of commercially insured Americans.

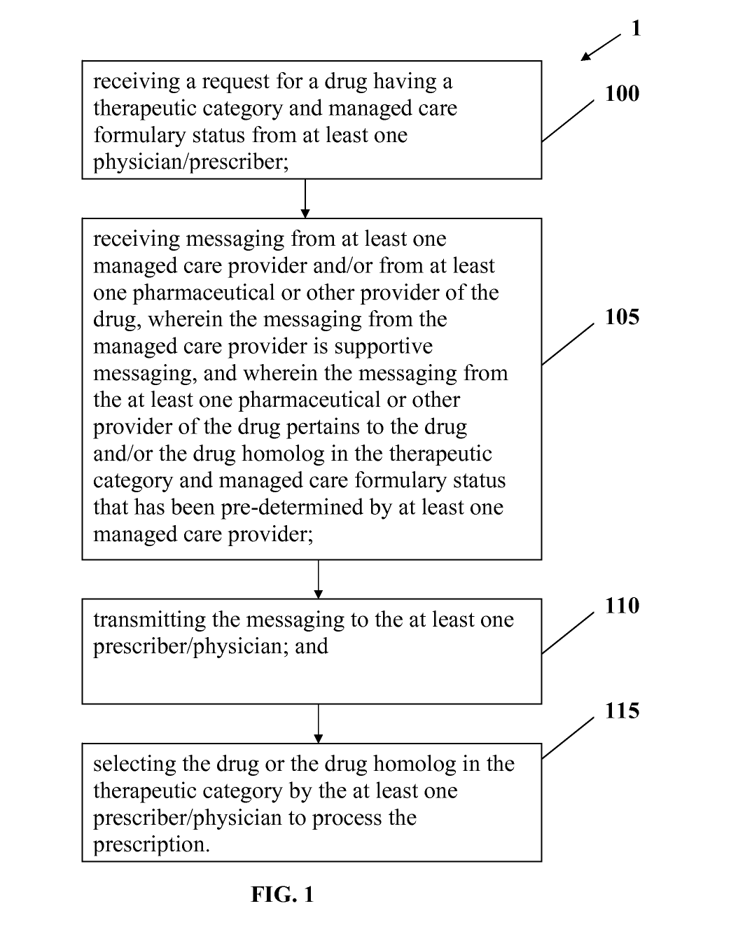

FIG. 1 depicts a method 1 for processing a prescription, comprising: a step 100, receiving a request for a drug having a therapeutic category and managed care formulary status from at least one physician/prescriber; a step 105, receiving messaging from at least one managed care provider and/or from at least one pharmaceutical or other provider of the drug, wherein the messaging from the managed care provider is supportive messaging, and wherein the messaging from the at least one pharmaceutical or other provider of the drug pertains to the drug and/or the drug homolog in the therapeutic category and managed care formulary status that has been pre-determined by at least one managed care provider; a step 110, transmitting the messaging to the at least one prescriber/physician; and a step 115, selecting the drug or the drug homolog in the therapeutic category by the at least one prescriber/physician to process the prescription. Hereinafter, a “drug homolog” is one drug of a group of many drugs that may be indicated for treatment of a given disease state or medical condition.

The apparatus 400 and the method 1 may provide an opportunity to deliver valuable Pharma messaging alongside drug information in, for example, split screen format may allow Pharma sponsored messaging to appear based on the therapeutic category and/or specific category that the physician has chosen to view.

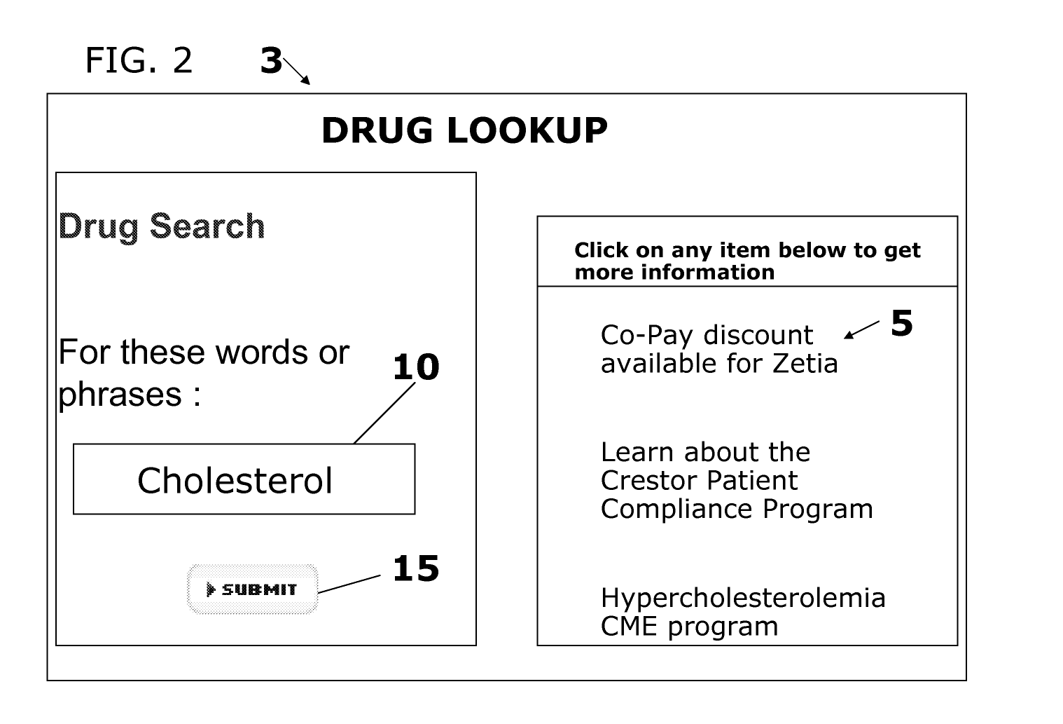

In an embodiment, the method 1 comprises advantageously transmitting messaging for the drug and/or drug homolog in the therapeutic category and managed care formulary status in a split screen format. FIG. 2 depicts a split screen presentation 3 of messaging 5 from three different pharmaceutical suppliers, other manufacturers of a drug or drug homolog, managed care providers or other sponsors of drug information that results when a physician/prescriber submits by selecting the submit button 15, a request for information for a drug or drug homolog 10 that treats a patient's medical condition, symptom or disease, such as for the medical condition where the patient has above normal levels of cholesterol in his blood.

In an embodiment, the method 1 comprises advantageously periodically updating the messaging for the drug and/or drug homolog in the therapeutic category and managed care formulary status. The average physician handles 11 or more generally from 10-20 different formularies, making the provision of formulary information at the point of care a service valued by physicians. Physicians would be able to select a “favorite” list of their patients' most common formularies using the Prescribing Resources website and easily access formulary status by drug or therapeutic category. Plan level data as an intermediate step to patient specific data would be part of an e-prescribing system. Physician would need to know patient's managed care plan to identify the formulary. Hereinafter “e-prescribing” means electronic prescribing. Hereinafter prescribing means creating a medical prescription ( [symbol] ) as an order in oral, written or electronic form by a qualified health care professional to a pharmacist or other therapist for a treatment to be provided to their patient. A prescription is a legal document which not only instructs in the preparation and provision of the medicine or device but indicates the prescriber takes responsibility for the clinical care of the patient and the outcomes that may or may not be achieved. E-prescribing using “Electronic transmission prescription” includes both image and data prescriptions. E-prescribing using “Electronic image transmission prescription” means any prescription order for which a facsimile of the order is received by a pharmacy from a licensed prescriber. E-prescribing using “Electronic data transmission prescription” means any prescription order, other than an electronic image transmission prescription, that is electronically transmitted from a licensed prescriber to a pharmacy.

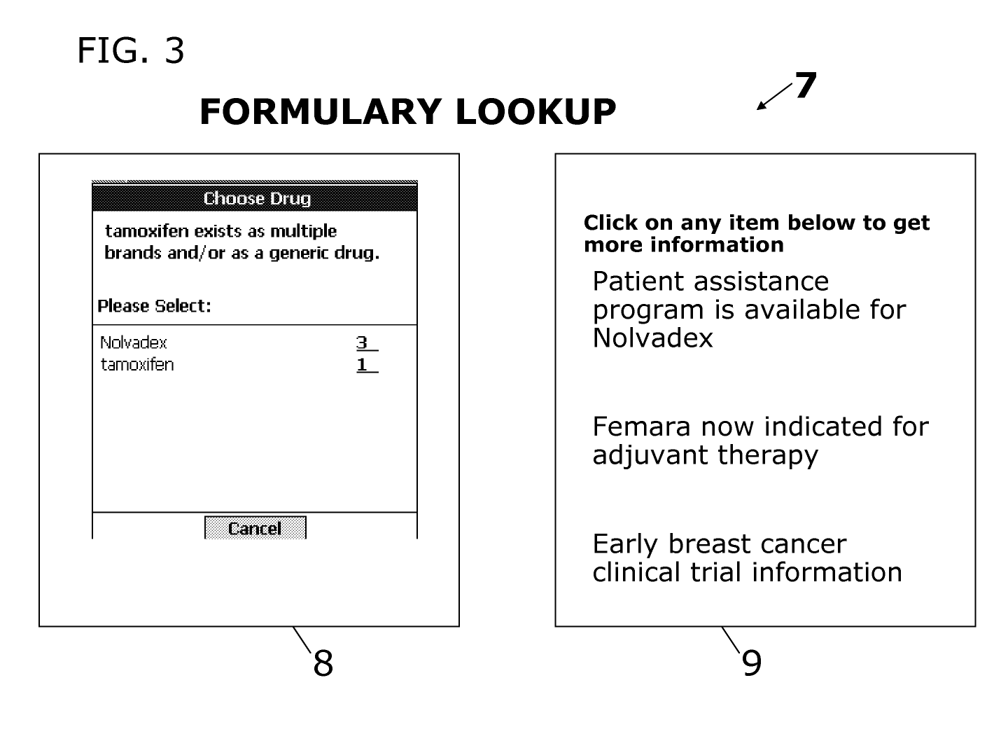

FIG. 3 depicts a split screen format showing formulary data in screen 8 and pharma sponsored messaging in screen 9. The split screen format 7 depicted in FIG. 3 affords the opportunity to deliver valuable Pharma sponsored messaging in screen 9 alongside formulary data in screen 8. Split screen format may allow Pharma sponsored messaging 9 to appear based on what the physician is entering and viewing in the formulary screen 8. Split screen format 7 may allow no impact or interference with formulary information 8 (satisfying managed care concerns). Split screen format 7 may allow managed care provider's messaging that could offset a lesser formulary status, i.e. higher co/pay, such as recent clinical developments, availability of brand sponsored compliance/persistency/adherence programs, discounts on co-pays, rebate programs, etc., other messaging such as adjunct therapy, continuing medical education (CME) and clinical trial opportunities.

In an embodiment, the method 1, comprises advantageously selecting the drug or the drug homolog in the therapeutic category in an e-prescribing transaction. E-prescribing is inevitable (i.e. Medicaid rules as suggested by the Centers for Medicare and Medicaid Services (CMS)) but physicians who were surveyed said they consider the cost of purchasing and implementing e-prescribing technology the biggest barrier to wider acceptance. A FREE, reputable, Health Care Insurance Privacy and Portability Act (HIPAA) compliant web-based, easy to use, electronic prescribing (e-prescribing) application would undoubtedly be valued and used by physicians and their staff. Requirements of e-prescribing application are straightforward leading to alliance and license with existing e-prescribing vendor or build strategy. A web-site for displaying the split screen format of apparatus 1 may be structured to allow practice to simply get required patient information (patient first and last name, birth date, home phone number and zip code) into e-prescribing system. In an embodiment, the website for displaying the split screen format of apparatus 1 may allow Pharma to have a presence in the process of prescribing electronically and Gain footing where only managed care and clinical applications have resided. Hereinafter “Pharma” means the pharmaceutical industry generally.

In an embodiment, the website for displaying the split screen format of apparatus 1 may enable RxHUB and Surescripts partnerships by providing patient level formulary data with same Pharma messaging opportunity and Electronic transmission to patient's pharmacy.

In an embodiment, the website for displaying the split screen format of apparatus 1 at modest fee. The comfort level developed with web-based system may be transferred to handheld application and provide significant advantage over competitive, non-Pharma supportive options. The handheld version may provide major benefit to e-prescribing vendor that Prescribing Resources may work with. The handheld version may integrate one-click compliance/persistence programs, enabling the physician/prescriber to automatically enroll patient into e-mail based reminder programs.

In an embodiment, drug, formulary, e-prescribing, and messaging information is maintained in relational databases.

In an embodiment, the same drug can have different formulary status across different managed care plans.

In an embodiment, different messaging opportunities for the same compound will be allowed based on sponsor goal and/or drug status, supportive messages for drugs in first tier/lower co-pay status, counter-messages for drugs in lower tier/higher co-pay status, and API's (automatic programming interfaces) can be created that will allow sponsored message delivery in other software applications and environments.

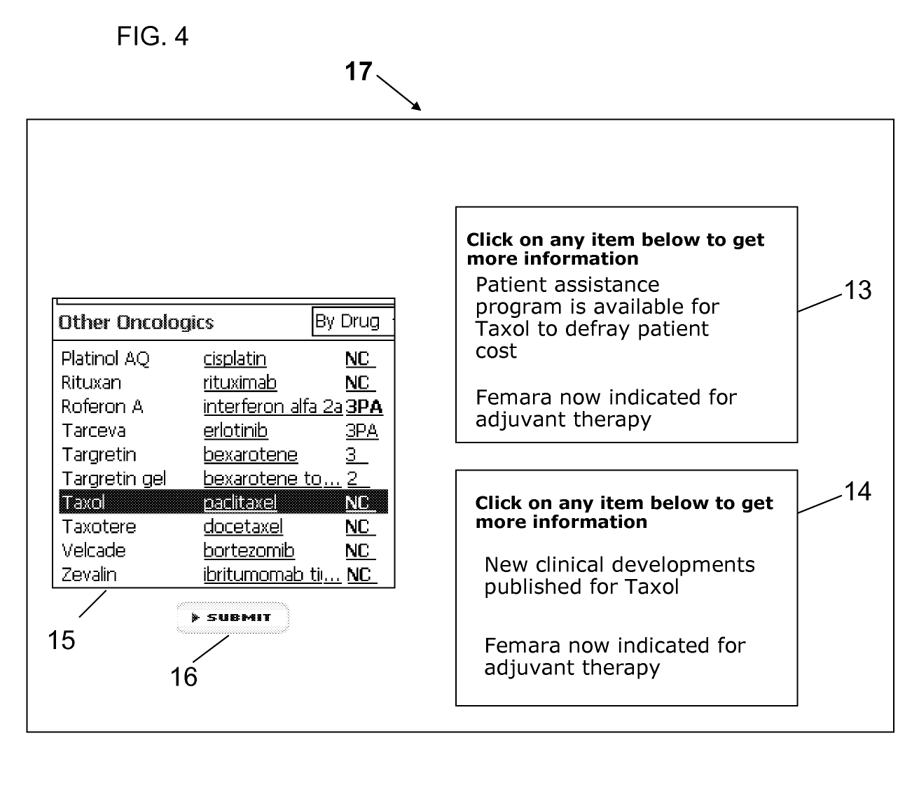

FIG. 4 depicts a split screen format 17 provided by the apparatus 400, using the method 1, illustrating multi-sponsored messaging in screens 13 and 14, based on what the physician/prescriber has entered in screen 15 AND the pharmaceutical supplier's or manufacturer of the drug or drug homolog or any drug sponsor's specific formulary status shown in screens 13 and 14. In FIG. 4, the physician/prescriber may select Taxol™ for example, by highlighting Taxol™ and pressing the submit button 16. Taxol is not covered so message in screen 13 could read as shown in screen 13. Alternatively, if Taxol was covered, a different message could read as in screen 14.

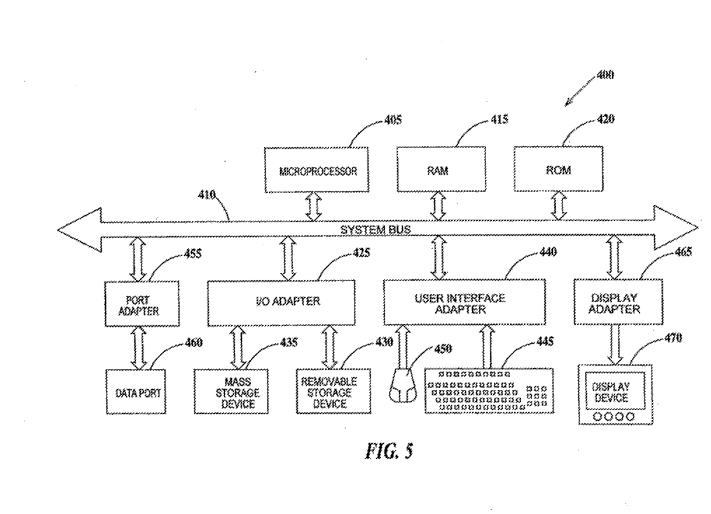

Generally, the method 1, depicted in FIG. 1 and described herein, may be practiced with a general-purpose computer and the method may be coded as a set of instructions on removable or hard media for use by the general-purpose computer. FIG. 5 depicts a schematic block diagram of a general-purpose computer 400 for practicing the present invention. The computer device 400 for processing a prescription for a patient, comprising: at least one storage device, 435 and 430; and a processor 405 disposed in communication with the at least one storage device, 435 and 430, the at least one storage device 435 and 430 storing: a program for controlling the processor 405; and the processor 405 operative with the program to: receive a request for a drug or a drug homolog having a therapeutic category and a managed care formulary status from at least one prescriber/physician; receive messaging from at least one managed care provider and/or from at least one pharmaceutical or other provider of the drug, wherein the messaging from the managed care provider is supportive messaging, and wherein the messaging from the at least one pharmaceutical or other provider of the drug pertains to the drug and/or the drug homolog in the therapeutic category and managed care formulary status that has been pre-determined by at least one managed care provider; transmit the messaging to the at least one prescriber/physician; and select the drug or the drug homolog in the therapeutic category by the at least one prescriber/physician to process the prescription.

In an embodiment, the managed care formulary status includes patient co-pay information.

In an embodiment, the messaging for the drug and/or drug homolog includes counter-detailing messages for drugs in lower tier/higher co-pay status. Hereinafter, “counter-detailing” means an “unsales pitch” which more accurately describes the goal: to counteract the influence of branded sales pitches by the pharmaceutical industry. Perhaps a more appropriate label would be “generic detailing” because that's what it really is. You just can't convey a negative message (e.g., “don't listen to drug company sales reps”), you must also convey a positive message: switch to the generic brand.

In an embodiment, the messaging for the drug and/or drug homolog includes supportive messages for drugs in first tier/lower co-pay status.

In an embodiment, the supportive messages include rebates, discounts and promotional incentives from the at least one pharmaceutical supplier.

In an embodiment, the messaging for the drug and/or drug homolog includes counter-detailing messages for drugs in lower tier/higher co-pay status.

In an embodiment, the supportive messaging supports the use of the drug and/or the drug homolog that are in favorable positions on the formulary of the managed care provider, e.g. giving a reason/clinically relevant message why a certain drug has been placed in the highest tier/lowest co-pay situation to persuade the at least one prescriber/physician to use the drug.

In an embodiment, the supportive messages include availability of patient assistance programs to defray patient cost, adjuvant therapy, clinical trial information and developments, continuing medical education (CME) programs and/or patient compliance programs.

In an embodiment, the processor is further operative with the program to: transmit the prescription to the patient's pharmacy.

In an embodiment, the processor is further operative with the program to: transmit the messaging for the drug and/or drug homolog in the therapeutic category and managed care formulary status to the managed care provider.

In an embodiment, the processor is further operative with the program to: receive disease and therapeutic category based resource centers.

In an embodiment, the processor is further operative with the program to: receive downloadable and printable patient/treatment information.

In an embodiment, the apparatus of claim 1, wherein the processor is further operative with the program to: receive downloadable handheld applications. In an embodiment, the processor is further operative with the program to: receive e-surveys. Hereinafter, “e-surveys” means electronic surveys using electronic imaging or electronic data transmission.

In an embodiment, the processor is further operative with the program to: receive e-detailing. Hereinafter, “e-detailing” means electronic counter-detailing or electronic generic-detailing using electronic imaging or electronic data transmission.

In FIG. 5, computer system 400 has at least one microprocessor or central processing unit (CPU) 405. CPU 405 is interconnected via a system bus 410 to a random access memory (RAM) 415, a read-only memory (ROM) 420, an input/output (I/O) adapter 425 for a connecting a removable data and/or program storage device 430 and a mass data and/or program storage device 435, a user interface adapter 440 for connecting a keyboard 445 and a mouse 450, a port adapter 455 for connecting a data port 460 and a display adapter 465 for connecting a display device 470.

ROM 420 contains the basic operating system for computer system 400. The operating system may alternatively reside in RAM 415 or elsewhere as is known in the art. Examples of removable data and/or program storage device 430 include magnetic media such as floppy drives and tape drives and optical media such as CD ROM drives. Examples of mass data and/or program storage device 435 include hard disk drives and non-volatile memory such as flash memory. In addition to keyboard 445 and mouse 450, other user input devices such as trackballs, writing tablets, pressure pads, microphones, light pens and position-sensing screen displays may be connected to user interface 440. Examples of display devices include cathode-ray tubes (CRT) and liquid crystal displays (LCD).

A computer program with an appropriate application interface may be created by one of skill in the art and stored on the system or a data and/or program storage device to simplify the practicing of method 1. In operation, information for or the computer program created to run method 1 is loaded on the appropriate removable data and/or program storage device 430, fed through data port 460 or typed in using keyboard 445.

The invention in its broader aspects is not limited to a singular preferred embodiment shown herein but may be practiced in different embodiments conceiving of differing fibers, fabrics, and arrangement and manipulations thereof. The invention in such broader aspects is limited only by the claims hereinafter made.

I claim:

1. An apparatus for processing a prescription for a patient, comprising:
a storage device; and
a processor disposed in communication with the storage device, the storage device storing:
a program for controlling the processor; and
the processor operative with the program to:
receive a request for a drug having a therapeutic category and managed care formulary status from at least one prescriber/physician;
transmit messaging for the drug and drug homolog in the therapeutic category and managed care formulary status that has been pre-determined by at least one pharmaceutical or other provider of the drug to the at least one prescriber/physician and to the managed care provider; and
select the drug or the drug homolog in the therapeutic category by the at least one prescriber/physician to process the prescription.

2. The apparatus of claim 1, wherein the managed care formulary status includes patient co-pay information.

3. The apparatus of claim 1, wherein the messaging for the drug and drug homolog includes counter-detailing messages for drugs in lower tier/higher co-pay status.

4. The apparatus of claim 1, wherein the messaging for the drug and drug homolog includes supportive messages for drugs in first tier/lower co-pay status.

5. The apparatus of claim 4, wherein the supportive messages include rebates, discounts and promotional incentives from the at least one pharmaceutical supplier.

6. The apparatus of claim 1, the messaging for the drug and drug homolog includes counter-detailing messages for drugs in lower tier/higher co-pay status.

7. The apparatus of claim 4, wherein the supportive messages include availability of patient assistance programs to defray patient cost, adjuvant therapy, clinical trial information and developments, continuing medical education (CME) programs and/or patient compliance programs.

8. The apparatus of claim 1, wherein the processor is further operative with the program to: transmit the prescription to the patient's pharmacy.

9. The apparatus of claim 1, wherein the processor is further operative with the program to: transmit the messaging for the drug and drug homolog in the therapeutic category and managed care formulary status to the managed care provider.

10. The apparatus of claim 1, wherein the processor is further operative with the program to: receive disease and therapeutic category based resource centers.

11. The apparatus of claim 1, wherein the processor is further operative with the program to: receive downloadable and printable patient/treatment information.

12. The apparatus of claim 1, wherein the processor is further operative with the program to: receive downloadable handheld applications.

13. The apparatus of claim 1, wherein the processor is further operative with the program to: receive e-surveys.

14. The apparatus of claim 1, wherein the processor is further operative with the program to: receive e-detailing.

15. A method of processing a prescription, comprising:
receiving a request for a drug having a therapeutic category and managed care formulary status from at least one physician/prescriber;
transmitting messaging for the drug and drug homolog in the therapeutic category and managed care formulary status that has been pre-determined by at least one pharmaceutical or other provider of the drug to the at least one prescriber/physician and to the managed care provider; and
selecting the drug or the drug homolog in the therapeutic category by the at least one prescriber/physician to process the prescription.

16. The method of claim 15, comprising selecting the drug or the drug homolog in the therapeutic category in an e-Prescribing transaction.

17. The method of claim 15, comprising transmitting messaging for the drug and drug homolog in the therapeutic category and managed care formulary status in a split screen format.

18. The method of claim 15, comprising periodically updating the messaging for the drug and drug homolog in the therapeutic category and managed care formulary status.
